(19) United States
(12) Patent Application Publication
(10) Pub. No.: US 2017/0068201 A1
(43) Pub. Date: Mar. 9, 2017

(54) SHEET CONVEYING APPARATUS, IMAGE READING APPARATUS, AND IMAGE FORMING APPARATUS

(71) Applicant: CANON KABUSHIKI KAISHA, Tokyo (JP)

(72) Inventor: Takayuki Fukushima, Toride-shi (JP)

(21) Appl. No.: 15/248,163

(22) Filed: Aug. 26, 2016

(30) Foreign Application Priority Data
Sep. 4, 2015 (JP) 2015-174814

(51) Int. Cl. G03G 15/00; B65G 45/12; H04N 1/00; B65H 5/06

(52) U.S. Cl. CPC G03G 15/6529; B65H 5/062; B65H 5/068; B65G 45/12; H04N 1/00795; H04N 1/00909; H04N 1/0032; B65H 2401/10; H04N 2201/0094

(57) ABSTRACT

A sheet conveying apparatus which conveys a sheet includes: a first rotating member made of a material which is positive with respect to the sheet in a triboelectric series; and a second rotating member made of a material which is negative with respect to the sheet in the triboelectric series, wherein the first and second rotating members are arranged in a conveyance direction of the sheet and arranged to be contact with the same surface of the sheet, and a foreign material is removed from the conveyed sheet by the first and second rotating members.

### BACKGROUND OF THE INVENTION

1. Field of the Invention

The present invention relates to a sheet conveying apparatus which conveys a sheet, and an image reading apparatus and an image forming apparatus including the sheet conveying apparatus.

2. Description of the Related Art

A sheet conveying apparatus that conveys a sheet has been provided in an image forming apparatus such as a copying machine, facsimile equipment, or a compound machine. For example, there is a known image reading apparatus which includes an automatic original conveying apparatus (hereinafter referred to as an auto document feeder (ADF)) that conveys an original corresponding to a sheet to be read.

An image reading apparatus has had a problem that a stripe-shaped image defect is generated on a read image when sheet dust generated from an original or a contaminant such as dust inside the apparatus is attached to platen glass provided in an original reading portion. In the image forming apparatus, there is concern that an image defect may be generated by a foreign material (sheet dust) attached to a conveyed recording medium (sheet).

Japanese Patent Laid-Open No. 2010-160402 proposes a configuration below as a solution to the problem due to the sheet dust generated from the original. That is, in Japanese Patent Laid-Open No. 2010-160402, an original guide portion includes a static electricity generating member that generates static electricity by friction due to contact with a conveying roller, and a cleaning member charged with static electricity generated by the static electricity generating member. In addition, the cleaning member is charged with static electricity generated by the static electricity generating member in order to electrostatically adsorb the foreign material attached to the original, thereby cleaning the foreign material such as sheet dust attached to the original during conveyance.

However, in the configuration of Japanese Patent Laid-Open No. 2010-160402, foreign materials are insufficiently removed.

### SUMMARY OF THE INVENTION

It is desirable to provide a sheet conveying apparatus which conveys a sheet including: a first rotating member made of a material which is positive with respect to the sheet in a triboelectric series; and a second rotating member made of a material which is negative with respect to the sheet in the triboelectric series, wherein the first and second rotating members are arranged in a conveyance direction of the sheet and arranged to be contact with the same surface of the sheet, and a foreign material is removed from the conveyed sheet by the first and second rotating members.

Further features of the present invention will become apparent from the following description of exemplary embodiments with reference to the attached drawings.

### BRIEF DESCRIPTION OF THE DRAWINGS

FIG. 1A is a perspective view of a foreign material removing unit, and FIG. 1B is a cross-sectional view of the foreign material removing unit;

FIG. 2 is a perspective view of an auto document feeder;

FIG. 3 is a partial cross-sectional view of the auto document feeder having the foreign material removing unit;

FIG. 4 is a partial cross-sectional view of the auto document feeder having the foreign material removing unit;

FIG. 5 is a cross-sectional view of the foreign material removing unit;

FIG. 6 is a cross-sectional view of an image forming apparatus having a foreign material removing unit;

FIG. 7 is an enlarged schematic view of a transfer portion and a fixing portion in the image forming apparatus; and

FIG. 8 is a diagram illustrating a triboelectric series of a resin material.

### DESCRIPTION OF THE EMBODIMENTS

Hereinafter, exemplary embodiments of the invention will be illustratively described in detail with reference to drawings. However, dimensions, materials, shapes, relative configurations, etc. of component parts described in embodiments below should be appropriately changed according to a configuration or various conditions of an apparatus to which the invention is applied. Therefore, the scope of the invention is not intended to be restricted only thereto unless a specific description is particularly given.

### First Embodiment

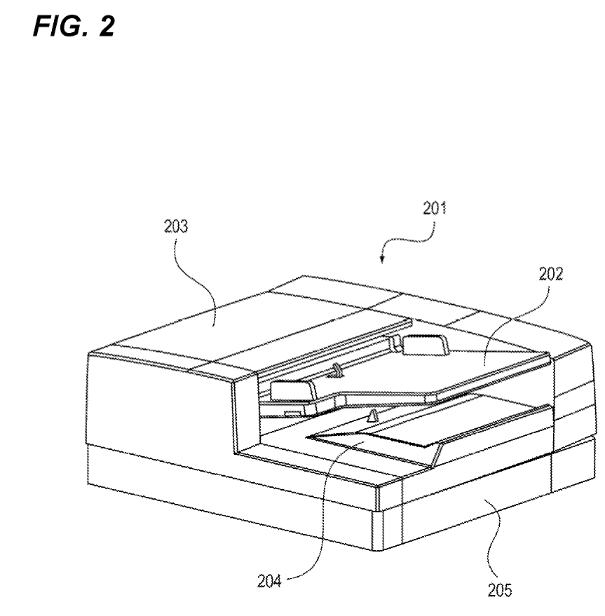

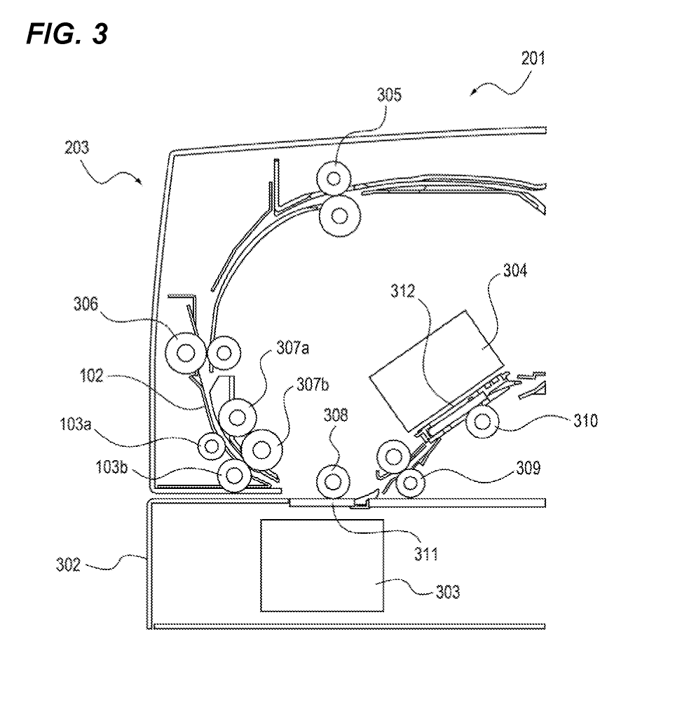

First, a description will be given of a schematic configuration of an image reading apparatus 205 including a sheet conveying apparatus according to a first embodiment of the invention using FIG. 2 and FIG. 3. Herein, an auto document feeder 201 that conveys an original (paper, for example) corresponding to a sheet to be read is illustrated as the sheet conveying apparatus.

As illustrated in FIG. 2, the auto document feeder 201 which serves as an original conveying apparatus for separately feeding a plurality of originals and reading an original image includes an original placing portion 202, a separately feeding portion (not illustrated), an original feeding portion 203, an original reading portion 311, and an original discharge portion 204. The original placing portion 202 is a portion for placing a fed original. The separately feeding portion is a portion that separately feeds originals placed on the original placing portion one by one using a roller or a belt (not illustrated). The original feeding portion 203 is a portion that conveys the originals separately fed by the separately feeding portion. The original reading portion 311 is a portion that reads an image of an original conveyed by the original feeding portion 203. The original discharge portion 204 is provided at a downstream of the original reading portion 311 in a conveyance direction to place an original after reading.

In addition, as illustrated in FIG. 3, members below are provided inside the original feeding portion 203 which serves as a conveying portion in order from an upstream side to a downstream side in the conveyance direction of the original corresponding to the sheet. A pair of conveying rollers 305 conveys an original separately fed by the separately feeding portion. A pair of registration rollers 306 is provided at a downstream of the pair of conveying rollers 305 in the conveyance direction to correct skew feeding of the fed original. Two pairs of foreign material removing rollers 307 are provided at a downstream of the pair of registration rollers 306 in the conveyance direction. Furthermore, the pairs of foreign material removing rollers 307 are provided at an upstream in the conveyance direction of a first platen glass 311 corresponding to a first original reading portion which is provided on a side of an image reading apparatus 302 for reading an image of a surface corresponding to one surface of the fed original. A first platen roller 308 is provided on a side opposing the first platen glass 311 to apply a force to the fed original to the first platen glass 311 when the image on the surface of the fed original is read. A pair of conveying rollers 309 is provided at a downstream of the first platen roller 308 in the conveyance direction to convey the fed original whose image on the surface is read. Second platen glass 312 is provided at a downstream of the pair of conveying rollers 309 in the conveyance direction, and is a second original reading portion for reading an image on a rear surface corresponding to the other surface of the fed original. A second platen roller 310 is provided on a side opposing the second platen glass 312 to apply a force to the fed original to the second platen glass 312 when the image on the rear surface of the fed original is read. A second image reading portion 304 reads the image on the rear surface of the fed original at a position of the second platen glass 312. Although not illustrated, a pair of discharge rollers is provided at a downstream of the second platen roller 310 in the conveyance direction to discharge the original to the original discharge portion 204 (see FIG. 2).

In addition, the image reading apparatus 302 for reading the image of the surface of the original conveyed by the auto document feeder 201 is provided below the auto document feeder 201. The first platen glass 311 corresponding to the first original reading portion is provided in the image reading apparatus 302 at a position opposing the first platen roller 308. In addition, a first image reading portion 303 for reading the image on the surface of the conveyed original through the first platen glass 311 is provided inside the image reading apparatus 302.

Herein, the above-described two pairs of foreign material removing rollers (pairs of rotating members) 307 include conveying rollers 307a and 307b corresponding to driven rotating members, and foreign material removing follower rotating members 103a and 103b which convey a sheet by nipping the sheet with the opposing conveying rollers 307a and 307b. The conveying rollers 307a and 307b are disposed on the rear surface side of the original, and the foreign material removing follower rotating members 103a and 103b are disposed on the surface side of the original (the first original reading portion side) corresponding to the same surface side of the sheet.

According to the above-described configuration, since the two pairs of foreign material removing rollers 307 are disposed at an immediate upstream of the first platen glass 311 corresponding to the first original reading portion, a foreign material such as sheet dust attached to the surface of the fed original may be removed. In this way, it is possible to remove the foreign material such as sheet dust regarded as a main factor of an image defect such as a stripe, and to provide stable image reading.

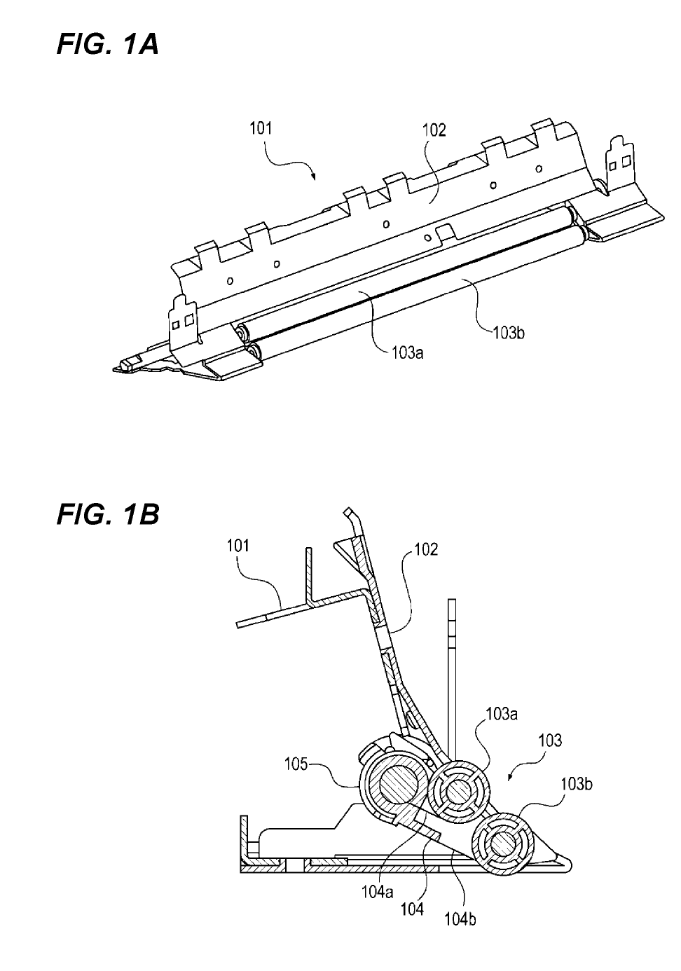

Next, a description will be given of an outline of a foreign material removing unit 101 including the two pairs of foreign material removing rollers 307 using FIGS. 1A and 1B. A conveyance guide 102, which is provided from the pair of registration rollers 306 up to an immediate upstream of the first platen glass 311 to guide the same surface side (surface side) of the original, is disposed in the foreign material removing unit 101. The foreign material removing follower rotating members 103a and 103b are provided in the conveyance guide 102 over a region including dimensions of the original in a width direction (main scanning direction) perpendicular to the conveyance direction (substantially whole region of the original in the width direction) so as to be rubbed with the whole fed original. Further, scrape members 104a and 104b abut on the conveyance guide 102 to scrape the foreign material (extraneous matter) such as sheet dust attached to the foreign material removing follower rotating members 103a and 103b. The scrape members 104a and 104b are attached to a pressure member 105 that allows the foreign material removing follower rotating members 103a and 103b to apply pressure to the opposing conveying rollers 307a and 307b (see FIG. 3), respectively.

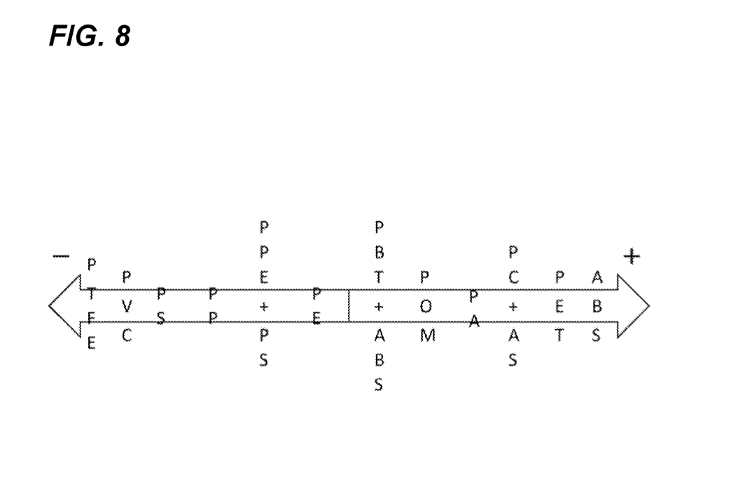

A foreign material removing follower rotating member 103 includes a first foreign material removing follower rotating member 103a serving as a first rotating member, and a second foreign material removing follower rotating member 103b serving as a second rotating member. The first foreign material removing follower rotating member 103a is made of a material which is positive with respect to the fed original in a triboelectric series. For example, one of ABS resin, PET resin, PC+AS resin, PA resin, POM resin, and PET+ABS resin is used as the material (quality of material) which is positive with respect to the original in the triboelectric series as illustrated in FIG. 8. The second foreign material removing follower rotating member 103b is made of a material which is negative with respect to the fed original in the triboelectric series. For example, one of PTFE resin, PVC resin, PS resin, PP resin, PPE+PS resin, and PE resin is used as the material (quality of material) which is negative with respect to the original in the triboelectric series as illustrated in FIG. 8. In this way, the foreign material removing follower rotating members 103a and 103b include resin members. The foreign material removing follower rotating members 103a and 103b may have opposite-polarities in the triboelectric series. That is, the foreign material removing follower rotating member 103a may be made of a material which is negative with respect to the fed original in the triboelectric series, and the foreign material removing follower rotating member 103b may be made of a material which is positive with respect to the fed original in the triboelectric series. In addition, order of a plus sign and a minus sign of the triboelectric series is not an issue in the conveyance direction of the original.

Further, the two pairs of foreign material removing rollers 307 are disposed in parallel at positions adjacent to each other in the conveyance direction of the original, and the two foreign material removing follower rotating members 103a and 103b are disposed on the same surface side of the original (herein, the surface side of the original). This disposition allows the original to be conveyed to the first platen glass 311 corresponding to the original reading portion without the removed foreign material flowing out, and it is possible to reduce the image defect such as the strip generated by the foreign material.

According to the above-described configuration, the fed original plunges into the pairs of foreign material removing rollers 307 by passing through the pair of conveying rollers 305 and the pair of registration rollers 306. Frictional electrification occurs by the conveyed original and the pairs of foreign material removing rollers 307, and the original and the pairs of foreign material removing rollers 307 are charged. In this way, a foreign material having one polarity (herein, a positive polarity) is removed by the first foreign material removing follower rotating member 103a that abuts on the surface of the conveyed original. Subsequently, a foreign material having the other polarity (herein, a negative polarity) unable to be removed in the first foreign material removing follower rotating member 103a is removed by the second foreign material removing follower rotating member 103b. Thereafter, the conveyed original passes through the first platen glass 311 corresponding to the original reading portion in a state in which foreign materials having both polarities are reduced. Further, an image of the original is read, and the original is discharged to the original discharge portion 204. This operation allows stripe-shaped images mainly caused by a foreign material such as sheet dust to be reduced, and thus it is possible to provide stable image reading.

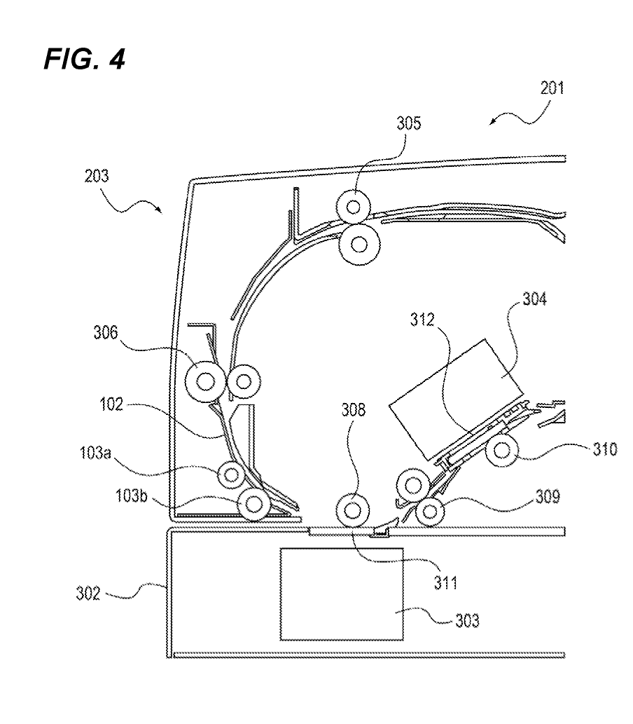

In addition, in the above-described embodiment, a description has been given using, as an example, the pairs of foreign material removing rollers 307 which nips the original with the foreign material removing follower rotating members abutting on the original on a read surface side (the surface side) and the conveying rollers abutting on the original on the rear surface side. However, the invention is not limited thereto. For example, as illustrated in FIG. 4, it is possible to employ a configuration including a guide member which guides the rear surface side of the original, and a foreign material removing follower rotating member which is provided to oppose the guide member and abuts on the original on the read surface side (surface side). This configuration achieves compactness, does not incur a problem in terms of control with previous and subsequent rollers, and does not generate nip. Thus, it is possible to suppress generation of a foreign material such as sheet dust.

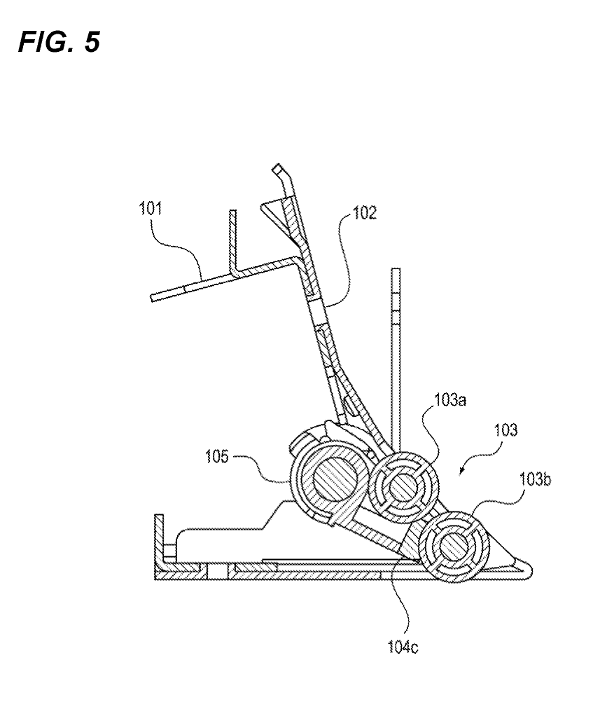

In addition, the above-described embodiment illustrates a configuration in which the scrape members 104 are provided for the first foreign material removing follower rotating member 103a and the second foreign material removing follower rotating member 103b, respectively. However, the invention is not limited thereto. For example, as illustrated in FIG. 5, it is possible to employ a configuration in which a single scrape member 104c abuts on the respective foreign material removing follower rotating members 103a and 103b. This configuration has effect that a configuration may be simplified, which leads to a cost reduction.

### Second Embodiment

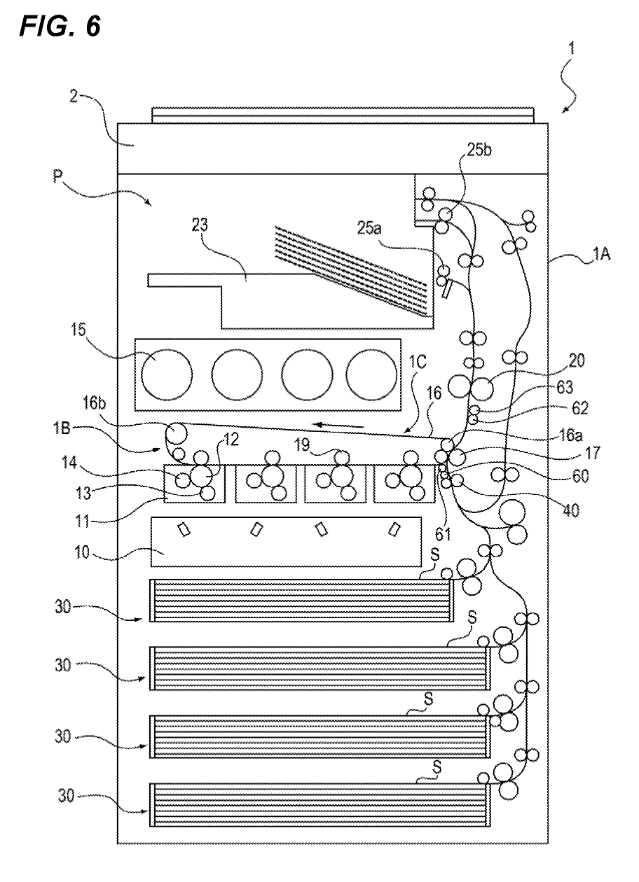

A description will be given of an image forming apparatus including a sheet conveying apparatus according to a second embodiment using FIG. 6. FIG. 6 is a schematic cross-sectional view illustrating a schematic configuration of the image forming apparatus. Herein, a sheet conveying apparatus that conveys a sheet corresponding to a recording target (recording medium) is given as an example of the sheet conveying apparatus, and a full color laser beam printer (hereinafter referred to as a printer) is given as an example of the image forming apparatus.

Referring to FIG. 6, a printer 1 corresponds to the image forming apparatus, a main printer body 1A corresponds to a main apparatus body of the image forming apparatus, an image forming portion 1B forms an image on a sheet, and a fixing portion 20 is provided. An image reading apparatus 2 corresponds to an upper apparatus substantially horizontally installed above the main printer body 1A. A sheet feeding device 30 is provided below the image reading apparatus 2 and the main printer body 1A. A toner cartridge 15 is detachably attachable with respect to the main printer body.

Image information read by the image reading apparatus 2 or image information input from external equipment such as a personal computer (not illustrated) is subjected to image processing, and then converted into an electric signal and transmitted to a laser scanner 10 of the image forming portion 1B. In addition, in the image forming portion 1B, a surface of a photosensitive drum 12 of each process cartridge 11 is scanned by a laser beam corresponding to image information of yellow, magenta, cyan, and black component colors emitted from the laser scanner 10. In this way, the surface of the photosensitive drum 12 equally charged at a predetermined polarity and electric potential by a charging unit 13 is successively exposed, and each electrostatic latent image of yellow, magenta, cyan, and black is successively formed on the photosensitive drum 12 of each process cartridge 11.

Thereafter, when the electrostatic latent image is developed and visualized by each color toner of each development device 14 of yellow, magenta, cyan, and black, a toner image of each color is formed on each photosensitive drum. The toner image of each color formed on each photosensitive drum is successively superposed on and transferred to an intermediate transfer belt 16 stretched on a driving roller 16a and a tension roller 16b by a primary transfer bias applied to a primary transfer roller 19. In this way, the toner image is formed on the intermediate transfer belt (image bearing member) 16.

Meanwhile, a sheet S (paper, for example) sent from the sheet feeding device 30 passes through a pair of registration rollers 40, and is sent to a secondary transfer portion including the driving roller 16a and a secondary transfer roller (transfer portion) 17. In the secondary transfer portion, toner images formed in the image forming portion 1B are collectively transferred onto the sheet S.

Subsequently, the sheet S onto which the toner image is transferred in this way is conveyed to the fixing portion 20, and the toner image is fixed as a color image on the sheet S by receiving heat and pressure in the fixing portion 20. Thereafter, the sheet S on which the image is fixed is discharged to a discharge space P by a pair of first discharge rollers 25a or a pair of second discharge rollers 25b, and is stacked on a protruding stacking portion 23 at a bottom of the discharge space P.

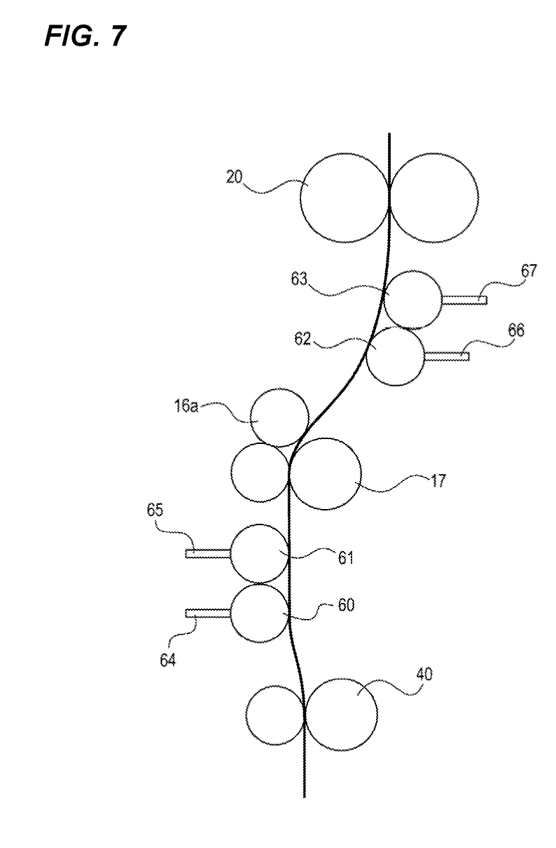

As illustrated in FIG. 7, in the secondary transfer portion, a first foreign material removing follower rotating member 60 and a second foreign material removing follower rotating member 61 serving as conveying apparatuses that convey the sheet S to the secondary transfer roller 17 are disposed in parallel in a conveyance direction. The first foreign material removing follower rotating member 60 and the second foreign material removing follower rotating member 61 are disposed at an immediate upstream (close to an upstream in the conveyance direction) of the secondary transfer roller 17, and are disposed on a surface side (toner transfer surface side) of the sheet S. Further, a first scrape member 64 and a second scrape member 65 abut on the first foreign material removing follower rotating member 60 and the second foreign material removing follower rotating member 61, respectively. The first scrape member 64 and the second scrape member 65 may not be provided for the first foreign material removing follower rotating member 60 and the second foreign material removing follower rotating member 61, respectively. A single scrape member may abut on the respective rotating members.

In addition, as illustrated in FIG. 7, referring to the fixing portion, a first foreign material removing follower rotating member 62 and a second foreign material removing follower rotating member 63 serving as conveying apparatuses that convey the sheet S to the fixing portion 20 are disposed in parallel in the conveyance direction. The first foreign material removing follower rotating member 62 and the second foreign material removing follower rotating member 63 are disposed at an immediate upstream (close to an upstream in the conveyance direction) of the fixing portion 20, and are disposed on a rear surface side (an opposite side from the toner transfer surface side) of the sheet S. Further, a first scrape member 66 and a second scrape member 67 abut on the first foreign material removing follower rotating member 62 and the second foreign material removing follower rotating member 63, respectively. The first scrape member 66 and the second scrape member 67 may not be provided for the first foreign material removing follower rotating member 62 and the second foreign material removing follower rotating member 63, respectively. A single scrape member may abut on the respective rotating members.

According to the above-described configuration, the conveyed sheet S plunges into the first foreign material removing follower rotating member 60 and the second foreign material removing follower rotating member 61 in order by passing through the pair of registration rollers 40. Frictional electrification occurs by the conveyed sheet S and the first and second foreign material removing follower rotating members 60 and 61, and the conveyed sheet S and the first and second foreign material removing follower rotating members 60 and 61 are charged. In this way, a foreign material having one polarity is removed by the first foreign material removing follower rotating member 60 that abuts on the conveyed sheet S. Subsequently, a foreign material having the other polarity unable to be removed in the first foreign material removing follower rotating member 60 is removed by the second foreign material removing follower rotating member 61.

Thereafter, the conveyed sheet S passes by the secondary transfer roller 17, and is directed to the fixing portion 20 to fix the sheet S on which a toner is carried. In this instance, frictional electrification occurs by the first and second foreign material removing follower rotating members 62 and 63 and the sheet S, and the sheet S and the first and second foreign material removing follower rotating members 62 and 63 are charged. In this way, a foreign material having one polarity is removed by the first foreign material removing follower rotating member 62 that abuts on the conveyed sheet S. Subsequently, a foreign material having the other polarity unable to be removed in the first foreign material removing follower rotating member 62 is removed by the second foreign material removing follower rotating member 63. In addition, a toner is fixed on the sheet S in the fixing portion 20, and the sheet S is discharged to the discharge space P.

This operation allows a reduction in image defect such as a stripe generated by a foreign material. Specifically, when a foreign material such as sheet dust is interposed in a cleaning blade in the intermediate transfer belt 16 of the transfer portion, it is possible to reduce a problem that a toner slips from the cleaning blade or a problem that a pressure roller of the fixing portion is contaminated.

### Other Embodiments

The above-described first embodiment illustrates a configuration, in which two rotating members having different polarities with respect to an original in a triboelectric series are disposed immediately before a first original reading portion, as a conveying apparatus that conveys the original to a first original reading portion. However, the invention is not limited thereto. For example, it is possible to employ a configuration in which two rotating members having different polarities with respect to an original in a triboelectric series are similarly provided as a conveying apparatus that conveys an original to a second original reading portion on a downstream side from a first original reading portion. In this case, the two rotating members are disposed on a rear surface side (second original reading portion side) of the original corresponding to the same surface side of the original.

In addition, the above-described second embodiment illustrates a configuration, in which two rotating members having different polarities with respect to a sheet in a triboelectric series are disposed immediately before a secondary transfer portion and a fixing portion, as a conveying apparatus that conveys a sheet to the secondary transfer portion and the fixing portion. However, the invention is not limited thereto. The conveying apparatus can immediately previously remove an extraneous matter such as sheet dust attached to a sheet. However, the conveying apparatus may be appropriately disposed as necessary.

Further, the above-described embodiments illustrate a copying machine as an image forming apparatus. However, the invention is not limited thereto. For example, it is possible to employ another image forming apparatus such as a printer or facsimile equipment or to employ another image forming apparatus such as a compound machine obtained by combining functions thereof. The same effect may be obtained by applying the invention to a sheet conveying apparatus in the image forming apparatus.

Furthermore, the above-described embodiments illustrate a sheet conveying apparatus integrally included in an image reading apparatus or an image forming apparatus. However, the invention is not limited thereto. For example, it is possible to employ a sheet conveying apparatus which is detachably attachable to the image reading apparatus or the image forming apparatus. The same effect may be obtained by applying the invention to the sheet conveying apparatus.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures and functions.

This application claims the benefit of Japanese Patent Application No. 2015-174814, filed Sep. 4, 2015, which is hereby incorporated by reference herein in its entirety.

What is claimed is:

1. A sheet conveying apparatus which conveys a sheet, the sheet conveying apparatus comprising:
a first rotating member made of a material which is positive with respect to the sheet in a triboelectric series; and
a second rotating member made of a material which is negative with respect to the sheet in the triboelectric series,
wherein the first and second rotating members are arranged in a conveyance direction of the sheet and arranged to be contact with the same surface of the sheet, and
a foreign material is removed from the conveyed sheet by the first and second rotating members.

2. The sheet conveying apparatus according to claim 1, further comprising
a scraping portion which scrapes an extraneous matter attached to the first and second rotating members.

3. The sheet conveying apparatus according to claim 1, wherein each of the first and second rotating members includes a resin member.

4. The sheet conveying apparatus according to claim 1, wherein a material of one of the first and second rotating members is one of ABS resin and PET resin which are positive with respect to the sheet in the triboelectric series, and a material of the other one of the rotating members is one of PTFE resin, PVC resin, PS resin, PP resin, PPE+PS resin, and PE resin which are negative with respect to the sheet in the triboelectric series.

5. The sheet conveying apparatus according to claim 1, wherein each of the first and second rotating members is a rotating member which conveys the sheet by nipping the sheet with an opposing driven rotating member.

6. The sheet conveying apparatus according to claim 1, wherein each of the first and second rotating members guides and conveys the sheet with an opposing guide member.

7. The sheet conveying apparatus according to claim 1, wherein each of the first and second rotating members is provided over a region including width of the sheet in a width direction perpendicular to the conveyance direction.

8. The sheet conveying apparatus according to claim 2, wherein the scraping portion includes a single scraping member abutting on each of the first and second rotating members.

9. The sheet conveying apparatus according to claim 8, wherein the first and second rotating members are disposed at positions adjacent to each other in the conveyance direction of the sheet.

10. An image reading apparatus comprising:
an image reading portion which reads an image of a conveyed original;
a first rotating member made of a material which is positive with respect to the original in a triboelectric series; and
a second rotating member made of a material which is negative with respect to the original in the triboelectric series,
wherein the first and second rotating members are arranged in a conveyance direction of the original and arranged to be contact with the same surface of the original, and
a foreign material is removed from the conveyed original by the first and second rotating members.

11. The image reading apparatus according to claim 10, further comprising
a scraping portion which scrapes an extraneous matter attached to the first and second rotating members.

12. The image reading apparatus according to claim 10, wherein a material of one of the first and second rotating members is one of ABS resin and PET resin which are positive with respect to the original in the triboelectric series, and a material of the other one of the rotating members is one of PTFE resin, PVC resin, PS resin, PP resin, PPE +PS resin, and PE resin which are negative with respect to the original in the triboelectric series.

13. The image reading apparatus according to claim 10, wherein each of the first and second rotating members is provided over a region including width of the original in a width direction perpendicular to the conveyance direction.

14. An image forming apparatus comprising:
an image bearing member which bears a toner image;
a transfer portion which transfers the toner image born by the image bearing member to a recording medium;
a fixing portion which fixes the toner image on the recording medium;
a first rotating member made of a material which is positive with respect to the recording medium in a triboelectric series; and
a second rotating member made of a material which is negative with respect to the recording medium in the triboelectric series,
wherein the first and second rotating members are arranged in a conveyance direction of the recording medium and arranged to be contact with the same surface of the recording medium, and
a foreign material is removed from the conveyed recording medium by the first and second rotating members.

15. The image forming apparatus according to claim 14, further comprising
a scraping portion which scrapes an extraneous matter attached to each of the first and second rotating members.

16. The image forming apparatus according to claim 14, wherein a material of one of the first and second rotating members is one of ABS resin and PET resin which are positive with respect to the recording medium in the triboelectric series, and a material of the other one of the rotating members is one of PTFE resin, PVC resin, PS resin, PP resin, PPE +PS resin, and PE resin which are negative with respect to the recording medium in the triboelectric series.

17. The image forming apparatus according to claim 14, wherein each of the first and second rotating members is provided over a region including width of the recording medium in a width direction perpendicular to the conveyance direction.
